(19) United States
(12) Patent Application Publication
(10) Pub. No.: US 2018/0100544 A1
(43) Pub. Date: Apr. 12, 2018

(54) BEARING PLATE FOR SUPERCHARGER

(71) Applicant: Eaton Corporation, Cleveland, OH (US)

(72) Inventors: Justin Hopkins, St. Louis, MO (US); Matthew Swartzlander, Battle Creek, MI (US)

(73) Assignee: Eaton Corporation, Cleveland, OH (US)

(21) Appl. No.: 15/837,047

(22) Filed: Dec. 11, 2017

Related U.S. Application Data
(63) Continuation of application No. PCT/US2016/036805, filed on Jun. 10, 2016.
(60) Provisional application No. 62/174,309, filed on Jun. 11, 2015.
(60) Provisional application No. 62/347,837, filed on Jun. 9, 2016.

(51) Int. Cl. F16C 33/10; F04C 29/04; F04C 27/00

(52) U.S. Cl. CPC F16C 33/1065; F04C 29/04; F04C 18/126; F04C 2240/50; F04C 2240/60; F04C 27/008

(57) ABSTRACT

A supercharger constructed in accordance to one example of the present disclosure includes a housing, first and second rotors, a bearing plate and a pair of sleeves. The first and second rotors are received in cylindrical overlapping chambers of the housing, the first rotor supported by a first rotor shaft, the second rotor supported by a second rotor shaft. The bearing plate is coupled to the housing and has an oil cavity side and an air cavity side. The bearing plate is formed of aluminum. The pair of sleeves can be received by the bearing plate and support respective bearings rotatably supporting respective first and second axle shafts. The pair of sleeves are formed of steel.

### CROSS-REFERENCE TO RELATED APPLICATIONS

This application is a continuation of International Application No. PCT/US2016/036805 filed Jun. 10, 2016, which claims the benefit of U.S. patent application No. 62/174,309 filed on Jun. 11, 2015 and U.S. patent application No. 62/347,837 filed on Jun. 9, 2016. The disclosures of the above applications are incorporated herein by reference.

### FIELD

The present disclosure relates generally to superchargers and more particularly to a bearing plate for a supercharger.

### BACKGROUND

Rotary blowers of the type to which the present disclosure relates are referred to as “superchargers” because they effectively super charge the intake of the engine. One supercharger configuration is generally referred to as a Roots-type blower that transfers volumes of air from an inlet port to an outlet port. A Roots-type blower includes a pair of rotors which must be timed in relationship to each other, and therefore, can be driven by meshed timing gears. Typically, a pulley and belt arrangement for a Roots blower supercharger is sized such that, at any given engine speed, the amount of air being transferred into the intake manifold is greater than the instantaneous displacement of the engine, thus increasing the air pressure within the intake manifold and increasing the power density of the engine. In many examples a supercharger can operate in high temperature environments. It is desirable to maintain the components of the supercharger in satisfactory operating condition to withstand significant temperature fluctuations.

The background description provided herein is for the purpose of generally presenting the context of the disclosure. Work of the presently named inventors, to the extent it is described in this background section, as well as aspects of the description that may not otherwise qualify as prior art at the time of filing, are neither expressly nor impliedly admitted as prior art against the present disclosure.

### SUMMARY

A supercharger constructed in accordance to one example of the present disclosure includes a housing, first and second rotors, a bearing plate and a pair of sleeves. The first and second rotors are received in cylindrical overlapping chambers of the housing, the first rotor supported by a first rotor shaft, the second rotor supported by a second rotor shaft. The bearing plate is coupled to the housing and has an oil cavity side and an air cavity side. The bearing plate is formed of aluminum. The pair of sleeves can be received by the bearing plate and support respective bearings rotatably supporting respective first and second axle shafts. The pair of sleeves are formed of steel.

According to other features, the bearings are press-fit into the sleeves. Outer races of the bearings can be formed of steel. Thermal expansion and contraction properties are similar to the sleeves such that the press-fit is maintained throughout thermal expansion and contraction events. The sleeves can each have a raised lip formed around an inner diameter thereof. The raised lips provide an axial barrier from the respective bearings. The bearing plate can further comprise a pair of seal pockets. Each seal pocket can be configured to receive a seal. The bearing plate can further define radial grooves disposed outboard of the seal pockets subsequent to a casting process. The radial grooves can be configured to receive the respective sleeves. The sleeves can be cast into the bearing plate. The sleeves can each define apertures that can receive aluminum during a casing process. The aluminum provides axial and radial retention of the steel sleeves.

According to additional features, the air cavity side defines an inset portion that leads to an outlet port of the supercharger. The inset portion has pressure relief slots formed thereon corresponding to each rotor and configured to minimize pressure and heat to improve isentropic efficiency of the supercharger. The pressure relief slots can each include a pair of arcuate wall sections that converge into each other at a valley and are configured to receive a radial component of air movement at the inset portion. The pressure relief slots can each further include a forward convex wall portion configured to receive an axial component of air movement at the inset portion.

A supercharger constructed in accordance to another example of the present disclosure includes a housing, a first rotor, a second rotor and a bearing plate. The housing has an inlet port and an outlet port. The first and second rotors are received in cylindrical overlapping chambers of the housing. The first rotor is supported by a first rotor shaft. The second rotor is supported by a second rotor shaft. The bearing plate is coupled to the housing and has an oil cavity side and an air cavity side. The air cavity side defines an inset portion that leads to the outlet port of the supercharger. The inset portion has pressure relief slots formed thereon corresponding to each of the first and second rotors and configured to minimize pressure and heat to improve isentropic efficiency of the supercharger.

According to other features, the pressure relief slots each include a pair of arcuate wall sections that converge into each other at a valley and are configured to receive a radial component of air movement at the inset portion. The pressure relief slots each further include a forward convex wall portion configured to receive an axial component of air movement at the inset portion.

According to additional features, the supercharger can further include a pair of sleeves received by the bearing plate and that support respective bearings. The bearings rotatably support the respective first and second axle shafts. The bearing plate can be formed of aluminum. The pair of sleeves are formed of steel. The bearings are press-fit into the sleeves. Outer races of the bearings are formed of steel. Thermal expansion and contraction properties of the bearings are similar to the sleeves such that the press-fit is maintained throughout thermal expansion and contraction events. The sleeves can each have a raised lip formed around an inner diameter thereof. The raised lips can provide an axial barrier from the respective bearings. The bearing plate further defines radial grooves disposed outboard of the seal pockets. The radial grooves can be configured to receive the respective sleeves. The sleeves are cast into the bearing plate.

### BRIEF DESCRIPTION OF THE DRAWINGS

The present disclosure will become more fully understood from the detailed description and the accompanying drawings, wherein:

FIG. 1 is a schematic illustration of an intake manifold assembly having a positive displacement blower or supercharger constructed in accordance to one example of the present disclosure;

FIG. 2 is a cross-sectional perspective view of a supercharger constructed in accordance to one example of the present disclosure;

FIG. 3 is a perspective oil cavity side view of a bearing plate constructed in accordance to one example of the present disclosure;

FIG. 4 is an exploded perspective air cavity side view of the bearing plate of FIG. 3;

FIG. 5 is an exploded perspective oil cavity side view of the bearing plate of FIG. 3; and

FIG. 6 is a cross-sectional view of the bearing plate take along lines 6-6 of FIG.

### DETAILED DESCRIPTION

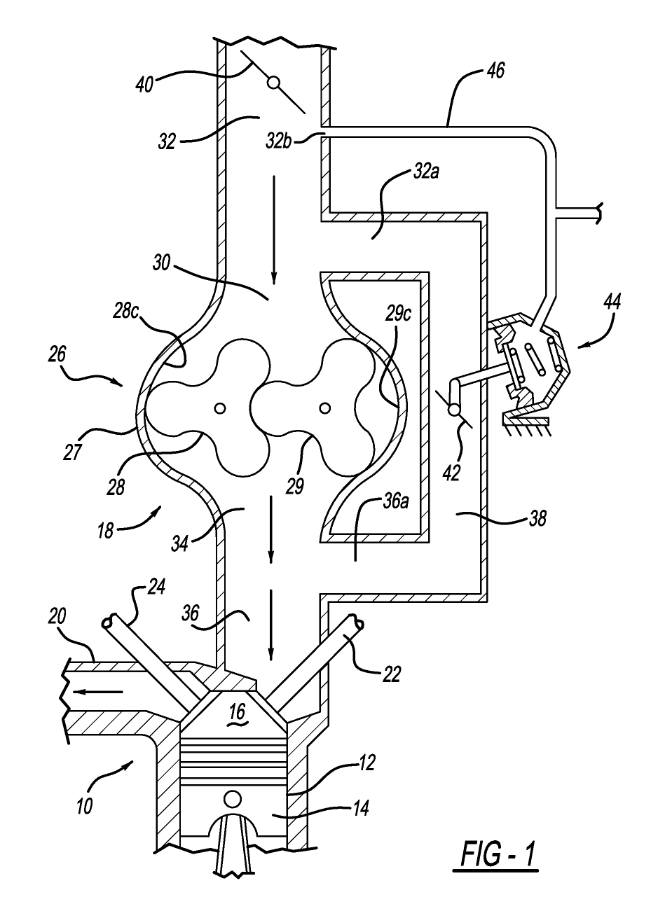

With initial reference to FIG. 1, a schematic illustration of an exemplary intake manifold assembly, including a Roots blower supercharger and bypass valve arrangement is shown. An engine 10 can include a plurality of cylinders 12, and a reciprocating piston 14 disposed within each cylinder and defining an expandable combustion chamber 16. The engine 10 can include intake and exhaust manifold assemblies 18 and 20, respectively, for directing combustion air to and from the combustion chamber 16, by way of intake and exhaust valves 22 and 24, respectively.

The intake manifold assembly 18 can include a positive displacement rotary blower 26, or supercharger of the Roots type. Further description of the rotary blower 26 may be found in commonly owned U.S. Pat. Nos, 5,078,583 and 5,893,355, which are expressly incorporated herein by reference. The blower 26 includes a housing 27 and a pair of rotors 28 and 29, each of which includes a plurality of meshed lobes. The rotors 28 and 29 are disposed in the housing 27 in a pair of parallel, transversely overlapping cylindrical chambers 28c and 29c, respectively. The rotors 28 and 29 may be driven mechanically by engine crankshaft torque transmitted thereto in a known manner, such as by a drive belt (not specifically shown). The mechanical drive rotates the blower rotors 28 and 29 at a fixed ratio, relative to crankshaft speed, such that the displacement of the blower 26 is greater than the engine displacement, thereby boosting or supercharging the air flowing to the combustion chambers 16.

The supercharger 26 can include an inlet port 30 which receives air or air-fuel mixture from an inlet duct or passage 32, and further includes a discharge or outlet port 34, directing the charged air to the intake valves 22 by means of a duct 36. The inlet duct 32 and the discharge duct 36 are interconnected by means of a bypass passage, shown schematically at reference 38. If the engine 10 is of the Otto cycle type, a throttle valve 40 can control air or air-fuel mixture flowing into the intake duct 32 from a source, such as ambient or atmospheric air, in a well know manner. Alternatively, the throttle valve 40 may be disposed downstream of the supercharger 26.

A bypass valve 42 is disposed within the bypass passage 38. The bypass valve 42 can be moved between an open position and a closed position by means of an actuator assembly 44. The actuator assembly 44 can be responsive to fluid pressure in the inlet duct 32 by a vacuum line 46. The actuator assembly 44 is operative to control the supercharging pressure in the discharge duct 36 as a function of engine power demand. When the bypass valve 42 is in the fully open position, air pressure in the duct 36 is relatively low, but when the bypass valve 42 is fully closed, the air pressure in the duct 36 is relatively high. Typically, the actuator assembly 44 controls the position of the bypass valve 42 by means of a suitable linkage. The bypass valve 42 shown and described herein is merely exemplary and other configurations are contemplated. In this regard, a modular (integral) bypass, an electronically operated bypass, or no bypass may be used.

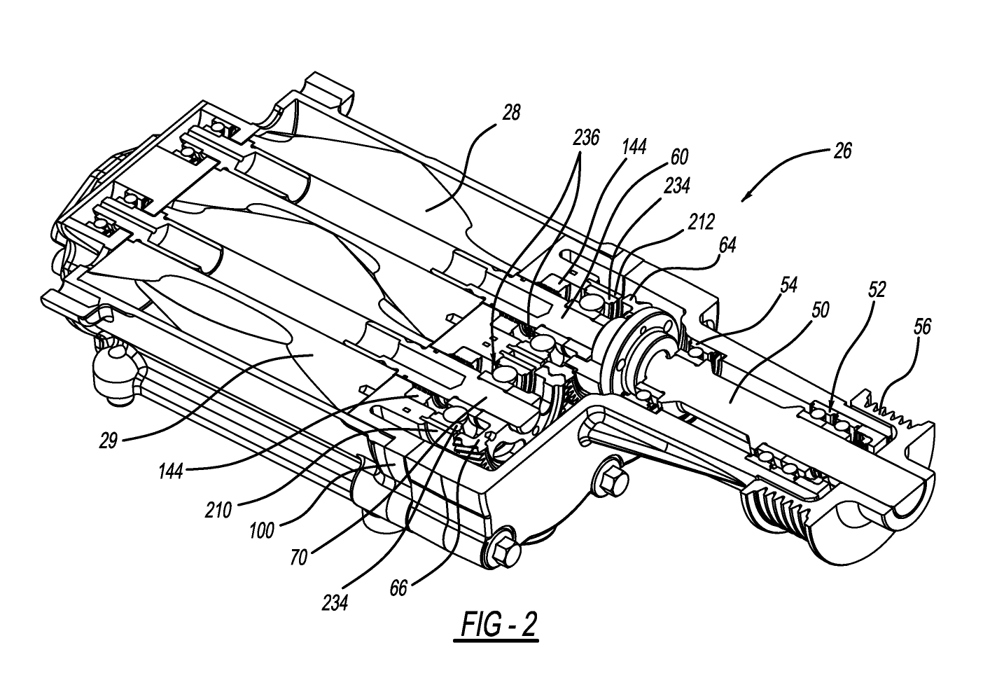

With additional reference now to FIG. 2, the supercharger 26 can include an input shaft 50 supported by a first bearing 52 and a second bearing 54 and driven by a pulley 56. The pulley 56 may be configured to transmit torque from the engine crankshaft (not shown) to the input shaft 50. The input shaft 50 is coupled to a rotor shaft 60 that supports the rotor 28. A pair of timing gears 64 and 66 rotatably couple a rotor shaft 70 that supports the rotor 29 for concurrent, opposite rotation with the rotor shaft 60.

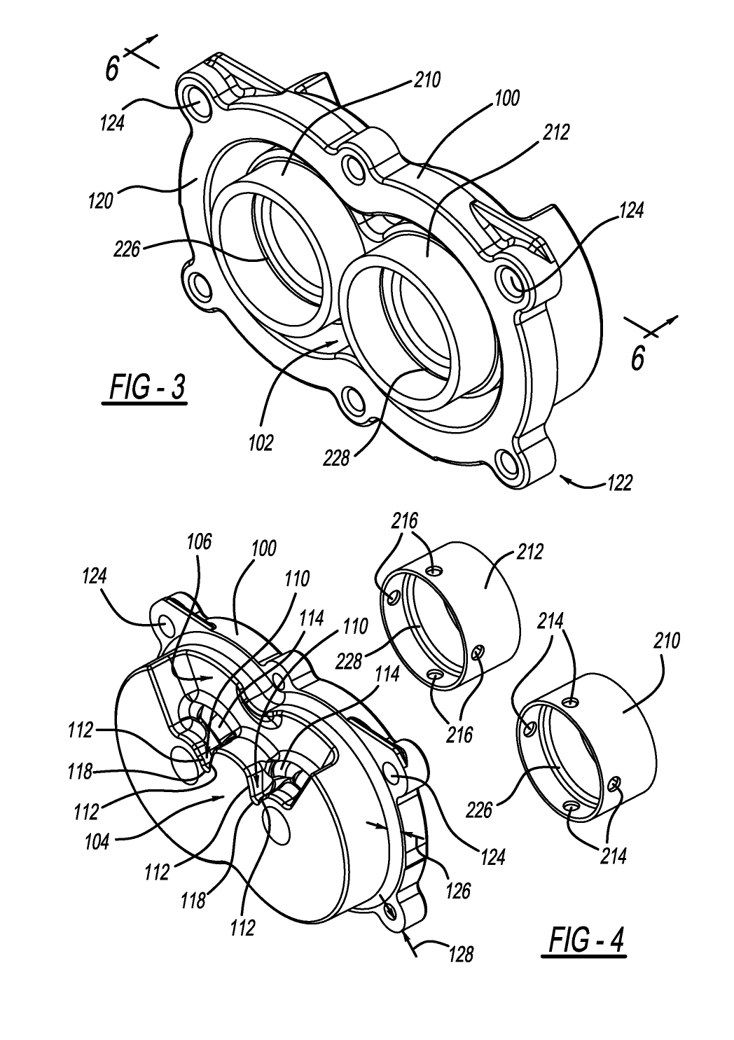

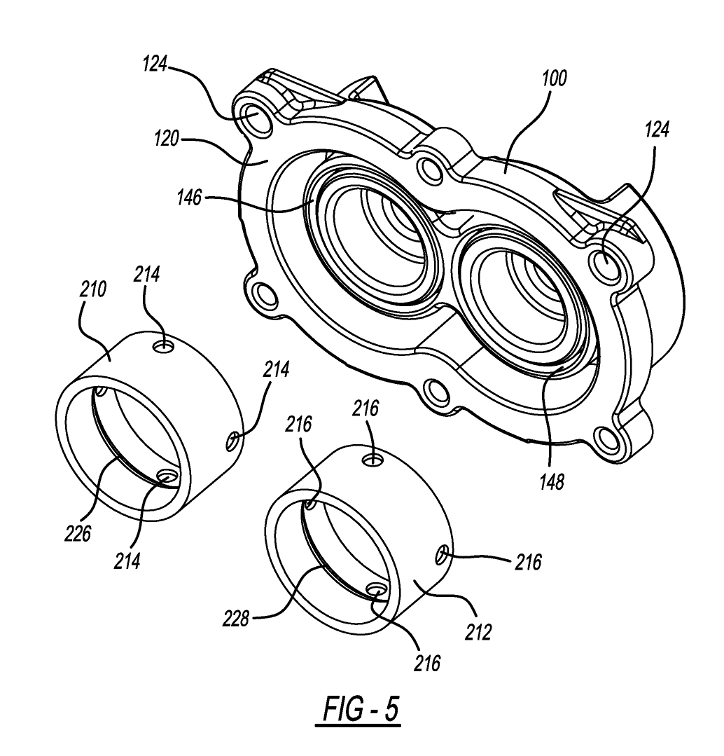

With particular reference now to FIGS. 2-6, additional features of the supercharger 26 will be described in greater detail. The supercharger 26 according to the present disclosure includes a bearing plate 100. The bearing plate 100 is optimized for reduced mass. The bearing plate 100 is formed of aluminum and includes an oil cavity side 102 (FIG. 3) and an air cavity side 104 (FIG. 4). The air cavity side 104 can define an inset portion 106 that leads to the outlet port 34 (FIG. 1). Pressure relief slots 110 can formed at the inset portion 106 on the air cavity side 104. The pressure relief slots 110 each can generally include a pair of arcuate wall sections 112 and a forward convex wall portion 114. The arcuate wall sections 112 converge into each other at a valley 118 and are generally configured to receive a radial component of air movement at the inset portion 106. The convex wall portions 114 are each configured to receive an axial component of air movement at the inset portion 106. The pressure relief slots 110 minimize unwanted pressure and heat and improve isentropic efficiency. In some examples, the meshing rotors 28 and 29 can form an air pocket that reduces in volume building a bubble of high pressure that can be detrimental to the efficiency of the supercharger 26. The pressure relief slots 110 are designed to relieve such high pressure and mitigate the potential detrimental impact. As a result, the pocket can remain open to the outlet port 34 versus creating an unwanted zone of high pressure. Heat and pressure buildup at the inset portion 106 is therefore minimized.

With particular reference to FIGS. 3 and 4, additional features of the bearing plate 100 will be described. An outer plate flange 120 includes a bolt pattern 122 having a series of bolt holes 124. The location of the bolt pattern 122 on the outer plate flange 120 is optimized to reduce mass. In one non-limiting example the outer plate flange 120 has a first minimum overlapping flange width 126 and a second minimum overlapping flange width 128. The second minimum flange width 128 is defined at the bolt holes 124. The first width 126 can be at least 5 mm. The second width 128 can be at least 3 mm. Other dimensions are contemplated. As can be appreciated the widths 126 and 128 are configured to help minimize mass and packaging space.

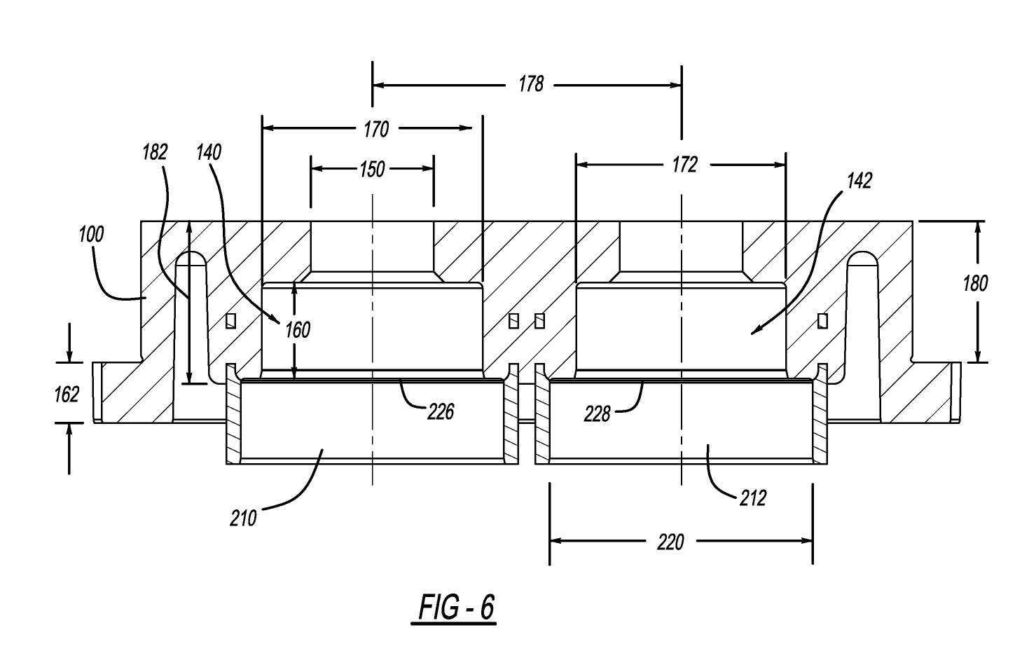

The bearing plate 100 can further define a pair of seal pockets 140 and 142 (FIG. 6) configured to each receive a seal 144 (FIG. 2). Radial grooves 146 and 148 are further provided in the bearing plate 100 outboard of the seal pockets 140 and 142 as a result of a casting process. As will be described herein, the radial grooves 146 and 148 receive sleeves formed of steel and configured to receive bearings in the supercharger 26.

Turning now to FIG. 6, additional exemplary dimensions will be described. The bearing plate 100 includes a shaft opening diameter 150 and a secondary lip chamfer 152. The shaft opening diameter 150 can be 17.25 mm. A 0.25 mm clearance to the rotor shaft may result. A seal bore depth 160 can be 13.46 mm. A flange width 162 can be 8.5 mm. A right hand seal outer diameter 170 can be 29.5 mm. A left hand seal outer diameter 172 can be 31 mm. A center distance 178 can be 43.39 mm. A first depth 180 can be 19.84 mm. A second depth 182 can be 22.09 mm. These dimensions are exemplary. In this regard, other dimensions may be used within the scope of the present disclosure.

The bearing plate 100 includes a pair of sleeves 210 and 212. The sleeves 210 and 212 can be formed of steel and can be cast into the aluminum bearing plate 100 during a casting process. The sleeves 210 and 212 can each define respective apertures 214 and 216 that can receive flowable aluminum during the casting process (see for example, FIG. 6). The casting process also results in the formation of the radial grooves 146 and 148 provided in the bearing plate 100 that receive the respective sleeves 210 and 212.

The sleeves 210 and 212 cooperate to increase the thermal capability of the supercharger 26. The steel sleeves 210 and 212 can accommodate higher temperatures. Steel has a lower coefficient of thermal expansion than the bearing plate 100 constructed of aluminum. In this regard, the bearing plate 100 can be formed of aluminum reducing mass of the overall supercharger 26 while the steel sleeves 210 and 212 are used to increase the thermal capability of the supercharger 26.

The steel sleeves 210 and 212 maintain retention to respective outer races 234 (FIG. 2) of front bearings 236 in high temperature environments (for example greater than 150 degrees Celsius) in the oil cavity side 102. Because the sleeves 210 and 212 and the outer races 234 of the bearings 236 are both steel, the expansion and contraction properties are similar such that the bearings 236 maintain a press-fit in the steel sleeves 210 and 212. The sleeves 210 and 212 can have an inner diameter 220 for receiving the outer races 234. The inner diameter 220 can be 37 mm. Other dimensions are contemplated. The sleeves 210 and 212 can further include an inner raised lip 226 and 228, respectively. The raised lips 226 and 228 can provide an axial barrier from the bearings 236 to the portion of the bearing plate 100 that provides the seal pockets 140 and 142.

In one example, the sleeves 210 and 212 can yield 140 MPa max stress at 200 degrees Celsius with no loss of retention. In one prior art configuration for a bearing plate without a sleeve, bearing retention can be experienced at 145 degrees Celsius. A maximum stress of 180 MPa can be realized at −40 degrees Celsius, exceeding the material yield strength limit.

The foregoing description of the examples has been provided for purposes of illustration and description. It is not intended to be exhaustive or to limit the disclosure. Individual elements or features of a particular example are generally not limited to that particular example, but, where applicable, are interchangeable and can be used in a selected example, even if not specifically shown or described. The same may also be varied in many ways. Such variations are not to be regarded as a departure from the disclosure, and all such modifications are intended to be included within the scope of the disclosure.

What is claimed is:

1. A supercharger comprising:
a housing;
a first rotor and a second rotor received in cylindrical overlapping chambers of the housing, the first rotor supported by a first rotor shaft, the second rotor supported by a second rotor shaft; and
a bearing plate coupled to the housing and having an oil cavity side and an air cavity side, the bearing plate formed of aluminum; and
a pair of sleeves received by the bearing plate and that support respective bearings rotatably supporting the respective first and second axle shafts, wherein the pair of sleeves are formed of steel.

2. The supercharger of claim 1 wherein the bearings are press-fit into the sleeves.

3. The supercharger of claim 2 wherein outer races of the bearings are formed of steel whereby thermal expansion and contraction properties are similar to the sleeves such that the press-fit is maintained throughout thermal expansion and contraction events.

4. The supercharger of claim 3 wherein the sleeves each have a raised lip formed around an inner diameter thereof, wherein the raised lips provide an axial barrier from the respective bearings.

5. The supercharger of claim 1 wherein the bearing plate further comprises a pair of seal pockets, each seal pocket configured to receive a seal.

6. The supercharger of claim 5 wherein the sleeves are cast into the bearing plate during a casting process.

7. The supercharger of claim 6 wherein the bearing plate further defines radial grooves disposed outboard of the seal pockets subsequent to the casting process, the radial grooves configured to receive the respective sleeves.

8. The supercharger of claim 6 wherein the sleeves each define apertures that can receive aluminum during the casting process.

9. The supercharger of claim 1 wherein the air cavity side defines an inset portion that leads to an outlet port of the supercharger, the inset portion having pressure relief slots formed thereon corresponding to each rotor and configured to minimize pressure and heat to improve isentropic efficiency of the supercharger.

10. The supercharger of claim 9 wherein the pressure relief slots each include a pair of arcuate wall sections that converge into each other at a valley and are configured to receive a radial component of air movement at the inset portion.

11. The supercharger of claim 10 wherein the pressure relief slots each further include a forward convex wall portion configured to receive an axial component of air movement at the inset portion.

12. A supercharger comprising:
a housing having an inlet port and an outlet port;
a first rotor and a second rotor received in cylindrical overlapping chambers of the housing, the first rotor supported by a first rotor shaft, the second rotor supported by a second rotor shaft; and
a bearing plate coupled to the housing and having an oil cavity side and an air cavity side, wherein the air cavity side defines an inset portion that leads to the outlet port of the supercharger, the inset portion having pressure relief slots formed thereon corresponding to each of the first and second rotors and configured to minimize pressure and heat to improve isentropic efficiency of the supercharger.

13. The supercharger of claim 12 wherein the pressure relief slots each include a pair of arcuate wall sections that converge into each other at a valley and are configured to receive a radial component of air movement at the inset portion.

14. The supercharger of claim 13 wherein the pressure relief slots each further include a forward convex wall portion configured to receive an axial component of air movement at the inset portion.

15. The supercharger of claim 12, further comprising:
a pair of sleeves received by the bearing plate and that support respective bearings, the bearings rotatably supporting the respective first and second axle shafts.

16. The supercharger of claim 15 wherein the bearing plate is formed of aluminum and the pair of sleeves are formed of steel.

17. The supercharger of claim 16 wherein the bearings are press-fit into the sleeves.

18. The supercharger of claim 17 wherein outer races of the bearings are formed of steel whereby thermal expansion and contraction properties are similar to the sleeves such that the press-fit is maintained throughout thermal expansion and contraction events.

19. The supercharger of claim 18 wherein the sleeves each have a raised lip formed around an inner diameter thereof, wherein the raised lips provide an axial barrier from the respective bearings.

20. The supercharger of claim 19 wherein the bearing plate further defines radial grooves disposed outboard of the seal pockets, the radial grooves configured to receive the respective sleeves, wherein the sleeves are cast into the bearing plate during a casting process.
